(19) United States
(12) Patent Application Publication
(10) Pub. No.: US 2005/0038867 A1
(43) Pub. Date: Feb. 17, 2005

(54) Method, system and program product for integrating web services on a client

(75) Inventors: Roderick C. Henderson, Apex, NC (US); Yongcheng Li, Cary, NC (US); Thomas F. McElroy, Raleigh, NC (US); Yih-Shin Tan, Raleigh, NC (US)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/640,899

(22) Filed: Aug. 14, 2003

(51) Int. Cl. G06F 15/16; G06F 15/173

(52) U.S. Cl. 709/217; 709/201; 709/224; 709/219

(57) ABSTRACT

Method, system and program product for integrating web services on a client computer. Selection criteria is used at a client computer to select web services. Once selected, service data is received from each of the web services. The service data is then aggregated at the client computer. The service data can be assembled into a custom page that can be displayed by a user. Further, the service data can be stored in a structured data object that allows for pre-fetching and caching of the service data.

### BACKGROUND OF THE INVENTION

1. Technical Field

The invention relates generally to integrating web services, and more specifically, to a solution that provides client-based aggregation and management of web services.

2. Background Art

Increasingly, the Internet is changing from a network primarily used to transfer files, to one that is used to provide services. A “web service” comprises an application that dynamically interacts with another application over the Internet. Typically, rather than transferring a file, the source application transfers data to the destination application, which in turn processes the data in some manner for display. For example, a weather web service can provide data on the weather for a given location that is subsequently formatted by a destination application for display as part of a custom web page.

An Internet portal (e.g., Yahoo, America Online, etc.) commonly allows a user to set up a personalized home page that can include customized selections of content. The personalized home page can include one or more “portlets” (e.g., sports, weather, business, etc.) that the user selects. Each portlet comprises a designated area of the home page in which information obtained from a web service is displayed. Unfortunately, in creating the home page, the user is limited to those selections that are provided by the Internet portal. Moreover, aggregation and management of the selected content occurs at the server.

As the popularity of web services increases, users increasingly desire more flexibility in selecting web services. Many users do not want to be limited to those selections provided by a particular Internet portal. Further, as the number of web services available increases, users also desire the ability to search and select web services based on specified criteria such as cost, reliability, etc. As a result, many users will become frustrated with the current limitations, and will desire to manage and aggregate content at their client computers.

As a result, a need exists for an improved system, method, and program product for integrating web services. In particular, a need exists for the selection and aggregation of web services to occur at a client computer, rather than through an Internet portal or the like.

### SUMMARY OF THE INVENTION

The invention provides a solution for integrating web services on a client computer. Specifically, under the present invention, a set of web services is selected at a client computer based on a user-specified selection criteria. Subsequently, service data from each of the selected web services is received and aggregated at the client computer. Further, one embodiment of the invention stores the service data in a structured data object. Use of the structured data object allows the service data to be cached, pre-fetched, etc. As a result, the invention allows a user to directly select desired web services at the client computer, without any constraints inherent in relying on those web services made available by a particular web site or another third party. Consequently, no mediator is necessary between the end user and providers of the web services.

A first aspect of the invention provides a method of integrating web services on a client computer, the method comprising: selecting a set of web services at the client computer based on selection criteria; receiving service data over a network from each of the selected set of web services; and aggregating the service data at the client computer.

A second aspect of the invention provides a method of integrating web services on a client computer, the method comprising: receiving selection criteria at the client computer; selecting a set of web services based on the selection criteria; receiving service data over a network from each of the selected set of web services; aggregating the service data at the client computer; and displaying the aggregated service data at the client computer.

A third aspect of the invention provides a system for integrating web services on a client computer, the system comprising: a selection system for selecting a set of web services at the client computer based on selection criteria; a communication system for receiving service data on the client computer over a network from each of the selected set of web services; and an aggregation system for aggregating the service data on the client computer.

A fourth aspect of the invention provides a program product stored on a recordable medium for integrating web services on a client computer, which when executed comprises: program code for selecting a set of web services at the client computer based on selection criteria; program code for receiving service data at the client computer over a network from each of the selected set of web services; program code for aggregating the service data at the client computer.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative system according to one embodiment of the invention;

FIG. 2 shows a more detailed view of a portion of the system of FIG. 1;

FIG. 3 shows an illustrative data flow for selecting web services according to another embodiment of the invention;

FIG. 4 shows an illustrative data flow for aggregating web services according to still another embodiment of the invention; and

FIG. 5 shows illustrative method steps used in integrating web services according to yet another embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a solution for integrating web services on a client computer. Specifically, under the present invention, a set of web services is selected at a client computer based on a user-specified selection criteria. Subsequently, service data from each of the selected web services is received and aggregated at the client computer. Further, one embodiment of the invention stores the service data in a structured data object. Use of the structured data object allows the service data to be cached, pre-fetched, etc. As a result, the invention allows a user to directly select desired web services at the client computer, without any constraints inherent in relying on those web services made available by a particular web site or another third party. Consequently, no mediator is necessary between the end user and providers of the web services.

It should be understood in advance that as used herein, “web service” is intended to refer to any type of service that can be delivered over a network. To this extent, a web service can provide data such as numerical data, text, graphics, sounds, or any combination thereof to another application over a network. Further, it should be understood that the term “set,” as used herein, denotes “one or more.”

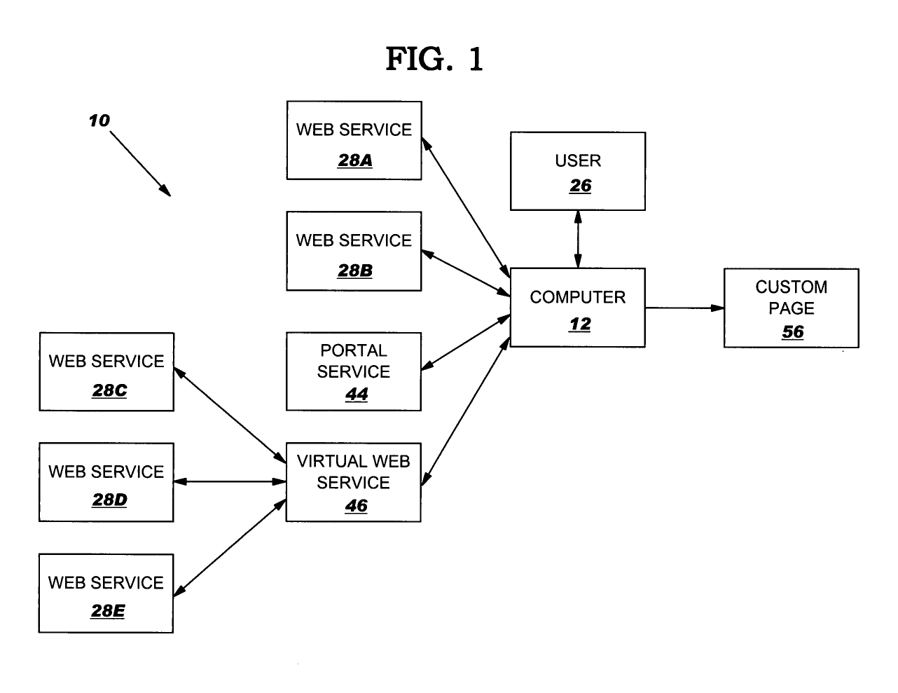

Turning to the drawings, FIG. 1 shows an illustrative system 10 according to one embodiment of the invention. System 10 allows a set of web services such as web services 28A-B, portal service 44, and/or virtual web service 46 to be selected, and data from the selected services to be aggregated at (client) computer 12. Portal service 44 and virtual web service 46 comprise web services that provide data in a particular manner as will be described below. Under the current invention, each web service 28A-B, portal service 44, and/or virtual web service 46 is selected based on selection criteria specified by user 26. Once selected, each web service communicates service data to computer 12 over a network, for example, the Internet. The service data is aggregated on computer 12, and can be assembled to generate a custom page 56 for display to user 26.

Many web services 28A-E generate and communicate data for a particular content area (e.g., weather, sports, financial, etc.). Data may be communicated upon request, upon a change in data, periodically, or some combination of these. Rather than selecting several web services 28A-E in varying content areas, a portal service 44 can be selected. Portal service 44 comprises a web service that generates and communicates portal pages. A portal page comprises a web page that includes one or more portlets. A portlet comprises an area of a portal page that is filled with content from a remote portlet server (not shown). Each portlet can include content from a different content area. It is understood that each portlet could comprise a standard or remote portlet (e.g., Web Services for Remote Portals). As a result, portal service 44 can communicate data from a variety of content areas, and frequently formats the data for presentation to user 26.

Still further, a virtual web service 46 can be selected. Virtual web service 46 comprises a web service that obtains data from a variety of web services 28C-E in a particular content area (e.g., weather). Virtual web service 46 then selects data from one or more of the web services 28C-E to communicate to computer 12 as its own data. From the perspective of computer 12, all the data it receives originates from virtual web service 46. However, virtual web service 46 may automatically change the web service(s) 28C-E from which the data is selected, or combine data from multiple web services 28C-E. The selection can be based on selection criteria such as performance, price, accuracy, etc. Selection criteria can be provided by user 26 (e.g., price) via computer 12 and/or can be implemented automatically by virtual web service 46 (e.g., performance).

For example, web services 28C-E can comprise distinct providers of weather-related data. Virtual web service 46 can receive the data from each of the web services 28C-E. However, virtual web service 46 can selectively use the weather data from one or more of the web services 28C-E to provide to computer 12. For example, web service 28C may be the most accurate, so virtual web service 46 can initially select its data. Over time, however, web service 28C may not timely provide weather data due to a communication failure or the like. As a result, virtual web service 46 may then provide a combination of weather data from web services 28D-E.

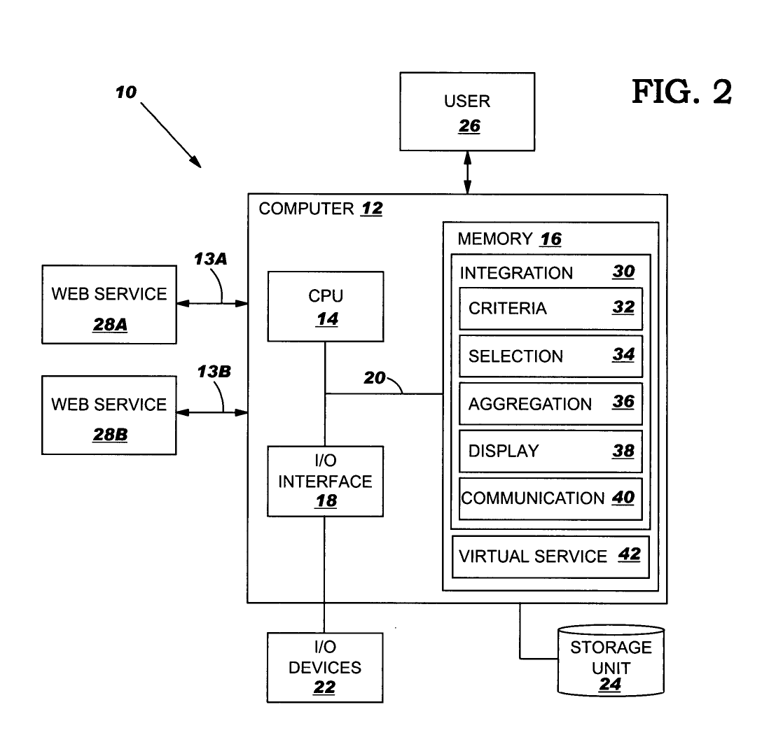

FIG. 2 shows a more detailed view of a portion of system 10. In particular, a more detailed view of one embodiment of (client) computer 12 is provided. As depicted, web services 28A-B and computer 12 communicate via communications links 13A-B. To this extent, each communications link 13A-B can comprise a direct hardwired connection (e.g., serial port), or a network. In the case of the latter, the network can comprise an addressable connection in a client-server (or server-server) environment that may utilize any combination of wireline and/or wireless transmission methods. In this instance, the server and client may utilize conventional network connectivity, such as Token Ring, Ethernet, WiFi or other conventional communications standards. Further, the network can comprise any type of network, including the Internet, a wide area network (WAN), a local area network (LAN), a virtual private network (VPN), etc. Where the client communicates with the server via the Internet, connectivity could be provided by conventional TCP/IP sockets-based protocol, and the client would utilize an Internet service provider to establish connectivity to the server.

As shown, computer 12 generally includes central processing unit (CPU) 14, memory 16, input/output (I/O) interface 18, bus 20, external I/O devices/resources 22, and a storage unit 24. CPU 14 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Storage unit 24 may comprise any type of data storage for providing more static storage of data used in the present invention. As such, storage unit 24 may include one or more storage devices, such as a magnetic disk drive or an optical disk drive. Moreover, similar to CPU 14, memory 16 and/or storage unit 24 may reside at a single physical location, comprising one or more types of data storage, or be distributed across a plurality of physical systems in various forms. Further, memory 16 and/or storage unit 24 can include data distributed across, for example, a LAN, WAN or a storage area network (SAN) (not shown).

I/O interface 18 may comprise any system for exchanging information to/from an external source. I/O devices 22 may comprise any known type of external device, including speakers, a CRT, LED screen, handheld device, keyboard, mouse, voice recognition system, speech output system, printer, monitor/display, facsimile, pager, etc. Bus 20 provides a communication link between each of the components in computer 12 and likewise may comprise any known type of transmission link, including electrical, optical, wireless, etc. In addition, although not shown, additional components, such as cache memory, communication systems, system software, etc., may be incorporated into computer 12.

Further, it is understood that computer 12 comprises any type of computing device capable of communicating with one or more other computing devices (e.g., web services 28A-B). For example, computer 12 can comprise a server, a desktop computer, a laptop, a handheld device, a mobile phone, a pager, a personal data assistant, etc. It is understood, however, that if computer 12 is a handheld device or the like, a display could be contained within computer 12, and not as an external I/O device 22 as shown for computer 12. Similarly, web services 28A-E (FIG. 1), portal service 44 (FIG. 1), and/or virtual service 46 (FIG. 1) can comprise any type of computing device, such as a server. To this extent, each of these web services typically includes the same elements as shown in computer 12 (e.g., CPU, memory, I/O interface, etc.). These have not been separately shown and discussed for brevity.

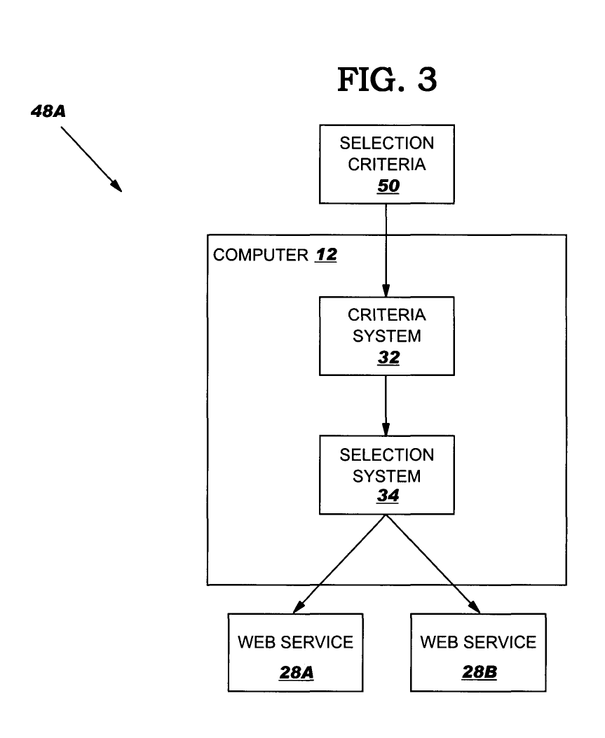

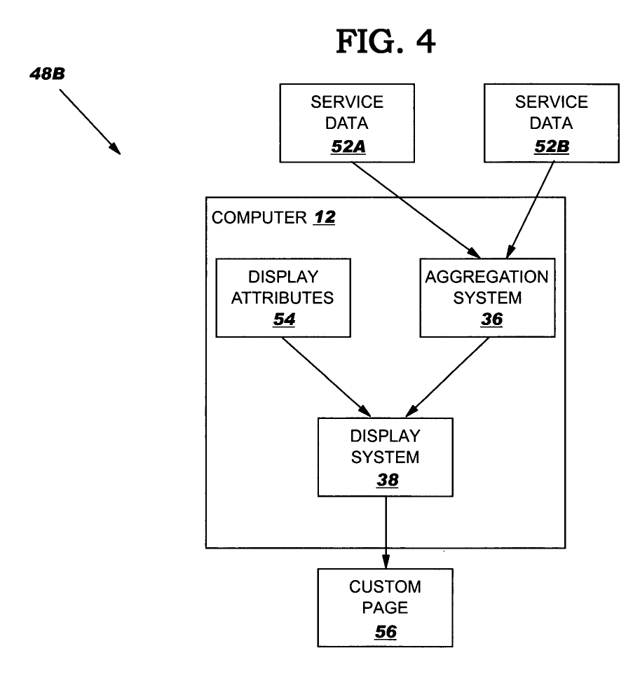

Shown stored in memory 16 is an integration system 30 that integrates web services on computer 12. Integration system 30 is shown including a criteria system 32, a selection system 34, an aggregation system 36, a display system 38, and a communication system 40. Communication system 40 sends and receives data from one or more other computing systems (e.g., web services 28A-B). When data is received, communication system 40 determines the validity of the data, whether it should be processed by computer 12, and if so, the corresponding system to which the data should be forwarded. Communication system 40 then provides the data to the appropriate system for processing. As such, it is understood that the functions performed by communication system 40 can be incorporated into the appropriate systems and/or be implemented apart from integration system 30. Communication system 40 is shown separately here for clarity. Operation of the remaining systems will be described below with reference to FIGS. 3 and 4. While various systems are shown implemented as part of integration system 30, it is understood that some or all of the systems can be implemented independently, combined, and/or stored in memory for one or more separate computers 12 that communicate over a network.

A virtual web service 42 is also shown in memory 16. Virtual web service 42 functions in the same manner as virtual web service 46 shown and discussed above with reference to FIG. 1. However, in this case, virtual web service 42 is implemented on computer 12 rather than on a separate computing system. It is understood that system 10 could include one or more virtual web services implemented on one or more distinct computing systems (e.g., virtual web service 46 shown in FIG. 1) and/or on computer 12 (e.g., virtual web service 42 shown in FIG. 2).

FIG. 3 shows an illustrative data flow 48A that occurs when selecting web services 28A-B according to one embodiment of the invention. As shown, selection criteria 50 is provided to criteria system 32 for processing. Selection criteria 50 can include, for example, a price, a reliability, a content area, an update speed, a geographic location, a data format, a time frame, etc. In order to receive selection criteria 50, criteria system 32 can present a user interface to user 26 (FIG. 1) that allows user 26 to enter selection criteria 50. As an alternative or in addition to a user interface, selection criteria 50 may be communicated from another computer, and/or read from storage (i.e., storage unit 24). In any event, criteria system 32 receives selection criteria 50 at computer 12, and forwards selection criteria 50 to selection system 34.

Selection system 34 selects web services 28A-B based on selection criteria 50. For example, selection system 34 can provide some or all of selection criteria 50 to a global service registry implemented using an open standard such as Universal Description, Discovery and Integration (UDDI) to determine available web services 28A-B. The global service registry comprises a central list on which web services 28A-B are registered. Use of the global service registry or the like allows end users to obtain a list of available web services 28A-B by communicating with a single location. However, it is understood that web services 28A-B can be located and selected using any manner. For example, selection system 34 can broadcast a request for a web service 28A-B meeting some or all of the constraints of selection criteria 50, and various web services 28A-B can respond as being available. In any event, selection system 34 will then select the web services 28A-B that best meet selection criteria 50. In one embodiment, selection system 34 makes the selection automatically. In another embodiment, user 26 (FIG. 1) is presented with a list of available web services 28A-B, and user 26 makes the selection. To select each web service 28A-B, selection system 34 can establish a connection with each web service 28A-B according to the requirements of the particular web service 28A-B.

Once selected, web services 28A-B communicate service data to computer 12 for processing. FIG. 4 shows an illustrative data flow 48B that occurs when service data 52A-B is received by computer 12 according to one embodiment of the invention. In the embodiment shown, service data 52A-B is received by aggregation system 36. Aggregation system 36 aggregates the service data 52A-B. In other words, aggregation system 36 combines the service data received from the various web services 28A-B into a single set of data that is then forwarded to display system 38 for further processing. In addition, aggregation system 36 can manage the communications with the selected web services 28A-B (FIG. 3). For example, aggregation system 36 may periodically request data from one or more of the web services 28A-B, respond to any messages from web services 28A-B, and/or disconnect from web services 28A-B.

As noted, display system 38 displays the aggregated service data at computer 12 as a custom page 56. In order to do this, display system 38 can obtain display attributes 54 for user 26 (FIG. 1). Display attributes 54 can be combined with the aggregated service data, and assembled into custom page 56. To this extent, display attributes 54 can comprise any desired settings or the like that impact the display of service data 52A-B. For example, display attributes 54 can include user preferences such as a skin, a theme, a color scheme, etc., and attributes of the display such as a screen resolution, color management, etc. Using display attributes 54, display system 38 organizes and locates service data 52A-B to build custom page 56.

In one embodiment, web services 28A-B (FIG. 3) are defined using a set of service attributes. For example, the web services description language (WSDL) can be used to define each web service 28A-B. Using the WSDL, web services 28A-B are defined by five major attributes: type, port type, binding, message, port, and service. The WSDL is extensible, consequently, additional attributes can be added or one or more of the attributes can be altered. For example, a display markup can be added to the set of service attributes of each web service 28A-B. The display markup can include information relating to the display of the service data for the corresponding web service 28A-B. For example, the display markup can include a desired color, font, screen dimension, screen location, etc. As a result, display system 38 can use the display markup to position and display service data 52A-B from each web service 28A-B on custom page 56.

Use of the display markup attribute or the like allows the display and user interface attributes to be separated from the web service itself (i.e., providing of service data). Consequently, service data 52A-B can be managed in a manner similar to data generated on computer 12. For example, aggregation system 36 can generate and maintain a structured data object for the service data 52A-B. Computer 12 can manage the structured data object according to the caching rules and the like of computer 12. The structured data object can also be used to pre-fetch service data 52A-B. Frequently, custom page 56 can include service data 52A-B that comprises a summary of a larger amount of data. Custom page 56 can provide user 26 (FIG. 1) with the ability to select to view the larger amount of data.

Aggregation system 36 could also anticipate that user 26 may seek to view the additional data, and can obtain the additional service data 52A-B from the appropriate web service 28A-B prior to its selection and store it in the structured data object. For example, custom page 56 can include the total amount of money in user's 26 bank accounts (e.g., savings account and checking account). When aggregation system 36 establishes a connection with the bank's web service, aggregation system 36 can create a structured data object for the account information. Subsequently, the account information can be filled in as service data is received from the bank's web service. User 26 can select to view the most recent transactions for the savings account. Upon this selection, display system 38 can first determine if the data object already includes the necessary service data. If the service data is included, it can be used to assemble the new page. If it is not available, aggregation system 36 can retrieve the necessary service data and store it in the data object for future use. Subsequently, user 26 may select to return to the initial account summary view, display system 38 can use the information stored in the structured data object to assemble the page. As a result, aggregation system 36 does not need to obtain this information from the bank's web service a second time.

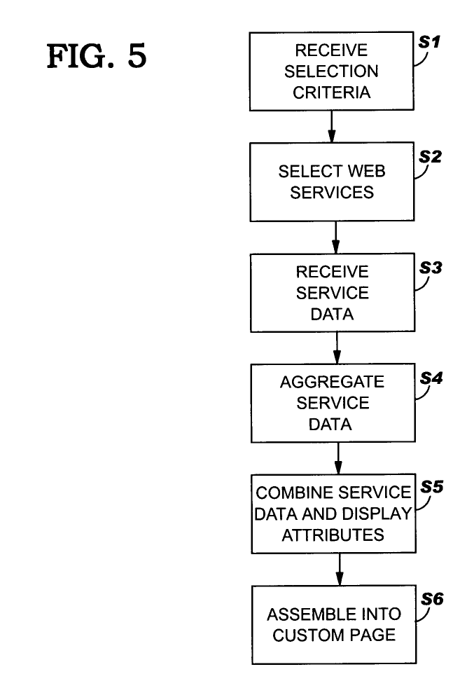

FIG. 5 shows illustrative method steps used in integrating web services according to one embodiment of the invention. In step S1, selection criteria is received at a client computer. In step S2, web services are selected based on the selection criteria. In step S3, service data is received from each of the selected web services over a network. In step S4, the received service data is aggregated at the client computer. In step S5, the service data and display attributes are combined, and in step S6, the combined data is assembled into a custom page that can be viewed by the user.

It is understood that the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method of integrating web services on a client computer, the method comprising:
selecting a set of web services at the client computer based on selection criteria;
receiving service data over a network from each of the selected set of web services; and
aggregating the service data at the client computer.

2. The method of claim 1, further comprising receiving the selection criteria at the client computer.

3. The method of claim 1, further comprising displaying the aggregated service data at the client computer.

4. The method of claim 3, wherein the displaying step includes:
obtaining display attributes for a user;
combining the display attributes with the service data; and
assembling the service data into a page.

5. The method of claim 4, wherein each of the set of web services is defined by a set of service attributes that includes a display markup, and wherein the display markup is used in the assembling step.

6. The method of claim 1, wherein at least one of the set of web services comprises a virtual web service.

7. The method of claim 6, wherein the virtual web service is located on the client computer.

8. The method of claim 1, further comprising storing the service data in a structured data object at the client computer.

9. A method of integrating web services on a client computer, the method comprising:
receiving selection criteria at the client computer;
selecting a set of web services based on the selection criteria;
receiving service data over a network from each of the selected set of web services;
aggregating the service data at the client computer; and
displaying the aggregated service data at the client computer.

10. The method of claim 9, wherein the displaying step includes:
obtaining display attributes for a user;
combining the display attributes with the service data; and
assembling the service data into a custom page.

11. The method of claim 9, wherein at least one of the set of web services comprises a virtual web service.

12. The method of claim 11, wherein the virtual web service is located on the client computer.

13. The method of claim 9, further comprising storing the service data in a structured data object at the client computer.

14. A system for integrating web services on a client computer, the system comprising:
a selection system for selecting a set of web services at the client computer based on selection criteria;
a communication system for receiving service data on the client computer over a network from each of the selected set of web services; and
an aggregation system for aggregating the service data on the client computer.

15. The system of claim 13, further comprising a criteria system for receiving the selection criteria at the client computer.

16. The system of claim 13, further comprising a display system for displaying the aggregated service data at the client computer.

17. The system of claim 13, wherein at least one of the set of web services comprises a virtual web service.

18. A program product stored on a recordable medium for integrating web services on a client computer, which when executed comprises:
program code for selecting a set of web services at the client computer based on selection criteria;
program code for receiving service data at the client computer over a network from each of the selected set of web services; and
program code for aggregating the service data at the client computer.

19. The program product of claim 18, further comprising:
program code for receiving selection criteria at the client computer; and
program code for displaying the aggregated service data at the client computer.

20. The program product of claim 18, further comprising:
program code for obtaining service data from a plurality of web services;
program code for selecting service data from at least one of the plurality of web services; and
program code for providing the selected service data to the program code for receiving as service data from a virtual web service.

21. The method of claim 1, wherein the selecting step includes:
providing at least a portion of the selection criteria to a global service registry;
obtaining a list of available web services from the global service registry;
presenting a user at the client computer with the list; and
receiving the set of web services selected by the user.

22. The method of claim 21, wherein the global service registry is implemented using the Universal Description, Discovery and Integration (UDDI) standard.

23. The method of claim 2, wherein the receiving the selection criteria step comprises presenting a user interface to a user at the client computer.

24. The system of claim 14, wherein each of the set of web services is defined by the web services description language (WSDL).

25. The system of claim 15, wherein the criteria system presents a user interface to a user at the client computer.

26. A method of generating a custom page on a client computer, the method comprising:
selecting a first web service at the client computer based on a first selection criteria;
selecting a second web service at the client computer based on a second selection criteria;
receiving service data over a network from each of the first and second web services at the client computer;
aggregating the service data at the client computer; and
assembling the custom page based on the aggregated service data.

27. The method of claim 26, wherein the selecting a first web service step includes:
providing at least a portion of the first selection criteria to a global service registry;
obtaining a list of available web services from the global service registry;
presenting a user at the client computer with the list; and
receiving the set of web services selected by the user.

28. The method of claim 27, wherein the global service registry is implemented using the Universal Description, Discovery and Integration (UDDI) standard.
